(19) United States
(12) Patent Application Publication
(10) Pub. No.: US 2002/0107623 A1
(43) Pub. Date: Aug. 8, 2002

(54) Apparatus for automatically ascertaining the setting for ski bindings

(76) Inventors: Jens Bongartz, Neuss (DE); Gerd Laschinski, Durroldorf (DE)

Correspondence Address: Joseph W. Berenato, III, Liniak, Berenato, Longacre & White, LLC, Ste. 240, 6550 Rock Spring Drive, Bethesda, MD, 20817, US

(21) Appl. No.: 09/773,922

(22) Filed: Feb. 2, 2001

(51) Int. Cl. G05D 1/00; G06F 7/00

(52) U.S. Cl. 701/49

(57) ABSTRACT

The invention describes an apparatus for automatically ascertaining the individual binding setting for ski bindings which is characterized by a weighing apparatus (2) for automatically ascertaining the body weight of a skier (P), a measurement apparatus (3) for automatically ascertaining the body height of the skier (P), and a measurement apparatus (4) for ascertaining the sole length of the skier (P), the weighing apparatus (2) and the measurement apparatuses (3, 4) being connected to one another in such a way that the parameters of body weight, height, and sole length are ascertained substantially simultaneously, and being connected to a calculation unit (5) in order to ascertain a binding setting automatically from the readings.

The present invention concerns an apparatus for automatically ascertaining the individual binding setting for ski bindings.

A ski binding is mounted on each ski in order to secure a ski boot immovably on the ski while in motion. In the event of a fall, however, the ski binding must release so that the boot separates from the ski, in order to prevent serious injuries. The force acting on the binding that results in release of the binding is regulated by way of the binding setting. The binding setting must be ascertained individually for each skier.

Ski binding settings are regulated by way of ISO Standard 11088. According to this, a method for setting bindings consists in using a special sliding gauge to measure the width of the head of the tibia (shinbone). The sole length of the ski boot must also be ascertained. Using these values and in consideration of age, gender, and skiing ability, the binding setting is ascertained from tables.

As an alternative to this, the ski binding setting can be calculated from a skier's body height and weight, and the sole length of the ski boot. Based on current knowledge, optimum calculation of the binding setting is possible if these three parameters are accurately measured. Since measurement of these three parameters is laborious and is performed manually, at present the parameters are in some case simply estimated or are ascertained inaccurately. An incorrect setting of the ski binding can therefore result.

It is therefore the object of the invention to ascertain the parameters necessary for determining the binding setting in an easy, quick, and precise manner.

According to the present invention, this object is achieved by way of an apparatus for automatically ascertaining the individual binding setting for ski bindings which is characterized by a weighing apparatus for automatically ascertaining the body weight of a skier, a measurement apparatus for automatically ascertaining the body height of the skier, and a measurement apparatus for ascertaining the sole length of the skier, the weighing apparatus and the measurement apparatuses being connected to one another in such a way that the parameters of body weight, height, and sole length are ascertained substantially simultaneously, and being connected to a calculation unit in order to ascertain a binding setting automatically from the readings.

The invention is thus based on the concept of simultaneously and automatically ascertaining the parameters of height, body weight, and ski boot sole length that are necessary for determining the ski binding setting, rather than performing individual measurements or estimates as in the existing art.

As in the case of the methods defined in the existing art and stipulated in ISO Standard 11088, the actual sole length of the ski boot being used is critical in this context. On the one hand, this can be measured directly. Alternatively, it is possible to ascertain the sole length of the skier's foot and to use a data table stored in the computer in which ski boot sizes for specific manufacturers and ski boot models are associated with the exact sole lengths of the ski boots, so that once a model has been selected, a conclusion can be drawn from the measured foot sole length as to the sole length of the selected ski boot, and can be used to determine the binding setting.

The measurement method for determining the individual parameters can, in principle, be selected arbitrarily. According to a preferred embodiment, however, provision is made for the weighing apparatus to have, in a manner known per se, a stepon surface on which a skier stands for determination of his or her weight. Load cells, for example, can then be provided between this step-on surface and a housing of the weighing apparatus on which the step-on surface rests, and by means of these the body weight of a skier standing on the step-on surface can be ascertained very accurately.

The body height measurement apparatus advantageously used in this case is a distance measuring instrument that is mounted at a defined height above the step-on surface of the weighing apparatus and determines the distance to the head of a person standing on the step-on surface, and ascertains the body height therefrom. For example, the body height measurement apparatus can ascertain the body height using an ultrasonic distance measurement, and for that purpose can have a transmitter for emitting an ultrasonic pulse and a receiver for receiving an acoustic pulse reflected from the skier's head, the body height then being calculated from the transit time between emission and detection of the acoustic pulse. In this fashion it is possible also to sense body height simultaneously during the measurement of body weight.

In a further embodiment of the invention, provision is made for the sole length measurement apparatus to be integrated into the housing of the weighing apparatus. For that purpose, a transparent panel can be recessed into the step-on surface, a camera being associated with the panel in order to record the shadow image of a foot standing on the panel, and the camera being connected to a computer in order to ascertain the sole length from the camera image. In this context, the transparent panel should exhibit diffuse scattering on its outward-facing surface. This diffusely scattering layer can be protected from abrasion and soiling by a thin transparent layer.

In the context of this embodiment, a deflection mirror is advantageously provided beneath the transparent panel in order to deflect a shadow image of the foot to the camera. A compact, flat configuration can thereby be achieved. Integration of the sole length measurement apparatus into the weighing apparatus makes it possible also to ascertain the sole length of a skier standing on the step-on surface while the body weight is being ascertained.

Regarding further advantageous embodiments of the invention, reference is made to the dependent claims and to the description below of an exemplary embodiment referring to the attached drawings, in which:

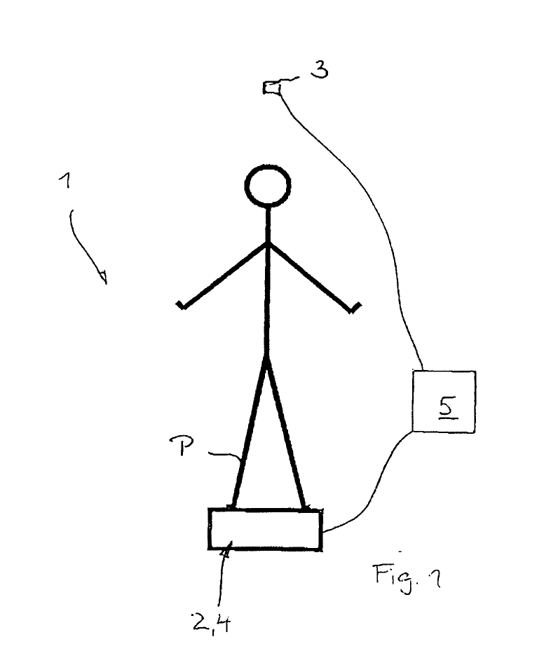

FIG. 1 shows a schematic view of an apparatus for automatically determining the individual binding setting for ski bindings;

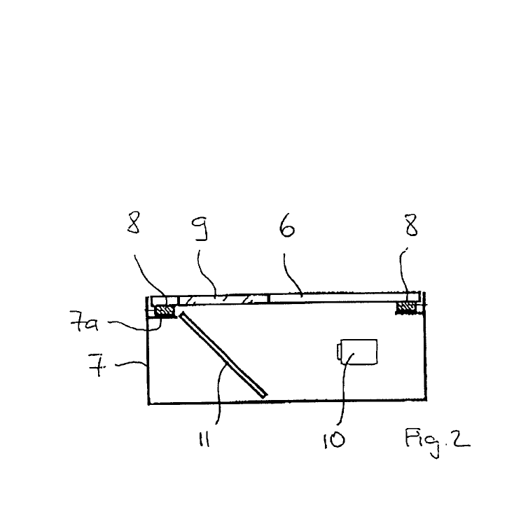

FIG. 2 shows, in a sectioned side view, a combined measurement unit for body weight and foot or boot sole length; and

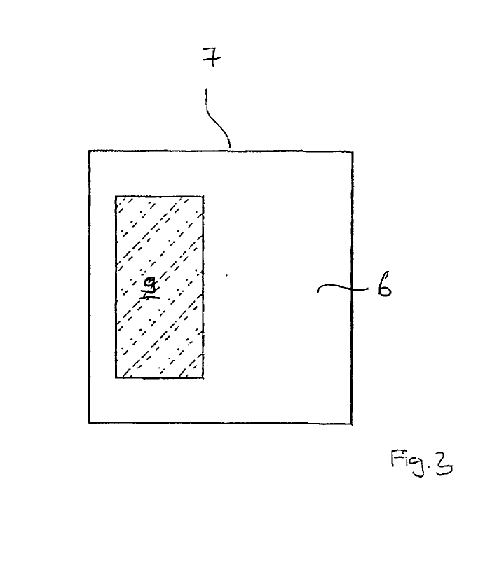

FIG. 3 shows a plan view of the measurement unit in FIG. 2.

FIG. 1 schematically depicts an apparatus according to the present invention with which the individual binding setting for ski bindings can be automatically ascertained. This apparatus 1 comprises a weighing apparatus 2 for automatically ascertaining the body weight of a skier P, a measurement apparatus 3 for automatically ascertaining the body height of skier P, and a measurement apparatus 4 for ascertaining the sole length of skier P. Weighing apparatus 2 and measurement apparatuses 3, 4 are connected to a calculation unit 5 which, from the readings of these apparatuses, automatically calculates a binding setting.

As is evident in particular from FIGS. 2 and 3, weighing apparatus 2 and sole length measurement apparatus 4 form a physical unit having a housing 7 whose open upper side is closed off by a step-on surface 6 that rests on a peripheral flange 7a of housing 7. Arranged between peripheral flange 7a and step-on surface 6 are load cells 8 by way of which the body weight of a skier P standing on step-on surface 6 can be ascertained.

A matte glass panel 9 is recessed into step-on surface 6. Panel 9 is arranged so that when skier P steps onto step-on surface 6, his or her left foot is located completely on it. The left foot is selected because it is generally larger than the right foot. The areas onto which the foot is to be placed can be made evident by way of a suitable mask on matte glass panel 9. The mask then also prevents excessive scattered light from entering housing 7. The resulting shadow image of the boot is deflected approximately 45°, by a deflection mirror 11 that is arranged beneath matte glass panel 9, to a camera 10 and recorded by the latter. Deflection mirror 11 makes possible a low overall height (approx. 20 cm) for the measurement unit when a long-focal-length camera is used. Too short a focal length for camera 10 would result in severe distortion of the image. The image from camera 10 is digitized and appropriately analyzed in a computer, in this case calculation unit 5, so that the ski boot sole length can be ascertained. In this context, the ski boot sole length can on the one hand be measured directly by the fact that the skier stands on step-on surface 6 while wearing the ski boot. In another mode, the sole length of the skier's foot is ascertained, and a conclusion as to the ski boot sole length is drawn based on the foot sole length. For this purpose, there is stored in the computer a data table in which ski boot lengths for specific manufacturers and ski boot models are associated with the exact sole lengths of the ski boots, so that once a specific ski boot model has been selected, a conclusion as to the ski boot sole length can be drawn from the measured foot sole length.

As depicted in FIG. 1, a distance measuring instrument that is arranged at a defined height of, for example, 2.5 m above step-on surface 6 is provided as body height measurement apparatus 3. Body height measurement apparatus 3 is in this case a distance measuring instrument that determines body height by way of an ultrasonic distance measurement. For that purpose, body height measurement apparatus 3 has a transmitter with which an ultrasonic pulse is emitted toward step-on surface 6. This acoustic pulse propagates through the air at the speed of sound, and is reflected from the head of a skier P standing on step-on surface 6. Also located in measurement unit 3 is a receiver which detects the reflected acoustic pulse. Body height is calculated from the transit time between the emission and detection of the acoustic pulse.

With the apparatus described above, the body weight, body height, and boot sole length of a skier P can be determined simultaneously and accurately. From the readings, the binding setting can then be determined by way of a suitable program in calculation unit 5. This setting can then optionally be forwarded automatically to an apparatus with which the binding setting on a ski binding can be automatically adjusted.

1. An apparatus for automatically ascertaining the individual binding setting for ski bindings, characterized by a weighing apparatus (2) for automatically ascertaining the body weight of a skier (P), a measurement apparatus (3) for automatically ascertaining the body height of the skier (P), and a measurement apparatus (4) for ascertaining the sole length of the skier (P), the weighing apparatus (2) and the measurement apparatuses (3, 4) being connected to one another in such a way that the parameters of body weight, height, and sole length are ascertained substantially simultaneously, and being connected to a calculation unit (5) in order to ascertain a binding setting automatically from the readings.

2. The apparatus as defined in claim 1, characterized in that the weighing apparatus (2) has a step-on surface (6).

3. The apparatus as defined in claim 2, characterized in that the body height measurement apparatus (3) is a distance measuring instrument that is mounted at a defined height above the step-on surface and ascertains the distance to the head of a person standing on the step-on surface, and from that the body height.

4. The apparatus as defined in claim 3, characterized in that the body height measurement apparatus (3) ascertains the body height using an ultrasonic distance measurement, and has a transmitter for emitting an ultrasonic pulse and a receiver for receiving an acoustic pulse reflected from the skier's head; and that the body height is calculated from the transit time between emission and detection of the acoustic pulse.

5. The apparatus as defined in one of claims 2 through 4, characterized in that the weighing apparatus (2) has load cells (8) in order to ascertain the body weight of a skier (P) standing on the step-on surface (6).

6. The apparatus as defined in one of claims 2 through 5, characterized in that the sole length measurement apparatus (4) is integrated into a housing (7) of the weighing apparatus (2).

7. The apparatus as defined in claim 6, characterized in that a transparent panel (9) is recessed into the step-on surface (6), a camera (10) is associated with the panel (9) in order to record the shadow image of a foot standing on the panel (9), and the camera (10) is connected to a computer (5) in order to ascertain the foot sole length from the camera image.

8. The apparatus as defined in claim 7, characterized in that a deflection mirror (11) is provided beneath the transparent panel (9) in order to deflect a shadow image of the foot to the camera (10).

9. The apparatus as defined in one of the foregoing claims, characterized in that the calculation unit (5) is connected to an apparatus for automatically adjusting the binding setting on a ski binding.
